(19) United States
(12) Patent Application Publication
(10) Pub. No.: US 2005/0158452 A1
(43) Pub. Date: Jul. 21, 2005

(54) Dip coating process using viscosity to control coating thickness

(75) Inventor: Steven D. Bush, Red Creek, NY (US)

Correspondence Address: Paul J. Maginot;MAGINOT, MOORE & BECK LLP, Bank One Center/Tower, 111 Monument Circle, Suite 3000, Indianapolis, IN, 46204-5115, US

(73) Assignee: Xerox Corporation

(21) Appl. No.: 10/759,970

(22) Filed: Jan. 16, 2004

(51) Int. Cl. B05D 1/00

(52) U.S. Cl. 427/8; 427/430.1

(57) ABSTRACT

A method and device are disclosed for controlling the thickness of a coating applied to a substrate by an immersion coating operation wherein the viscosity of the coating solution is sensed and adjustments to the differential rate between the pull rate of the substrate and the upward flow rate of the coating solution are implemented during a dipping cycle.

### BACKGROUND AND SUMMARY

This disclosed device and method relates generally to manufacturing photoreceptors for photocopier and printer devices and more particularly to a controller and a method and device for controlling the thickness of a coating formed using immersion or dip coating of a photoreceptor into a coating solution using viscosity of the solution as a measured parameter.

Photocopiers and laser printers use toner and heat to produce an image on a sheet of paper or other media in a process known as electro-photography. In the art of electro-photography an electro-photographic plate or photoreceptor comprising a photoconductive insulating layer on a conductive layer is imaged by first uniformly electrostatically charging the imaging surface of the photoconductive insulating layer. The photoreceptor is then exposed to a pattern of activating electromagnetic radiation such as light, which selectively dissipates the charge in the illuminated areas of the photoconductive insulating layer while leaving behind an electrostatic latent image in the non-illuminated area. This electrostatic latent image may then be developed to form a visible image by depositing finely divided toner particles on the surface of the photoconductive insulating layer. The resulting visible toner image can be transferred to a suitable receiving member such as paper. This imaging process may be repeated many times with reusable photoconductive insulating layers.

The photoreceptors are usually multilayered drums or belts. These photoreceptors comprise a substrate, an optional hole-blocking layer, a charge generating layer, and a charge transport layer and, in some embodiments, an anti-curl backing layer. In manufacturing photoreceptors for photocopiers, an organic photoconductor (OPC) is often used to coat the substrate. The OPC has a small dark current, is an inexpensive material, and yields high productivity due to ease of manufacturing. The OPC that has been used as an electrophotographic sensitive material includes a two layer structure of a charge generation layer (CGL) and a charge transfer layer (CTL).

The reason why the charge transfer layer is needed is that the withstand voltage of the charge generation layer is low. The charge transfer layer is necessary to improve the withstand voltage of the OPC used as a light switch.

One common technique employed to manufacture photoreceptors involves immersion or dip coating of the substrate. Dip coating comprises dipping or immersing an uncoated or coated substrate, such as a drum, into a coating vessel or dip tank containing a bath of liquid coating material. The dipped substrate is thereafter withdrawn and the liquid coating adhering thereto is dried.

The liquid coating material in the bath is generally circulated upwardly in the dip tank from an inlet at the bottom of the dip tank and allowed to overflow from the bath. Typically, the coating is continuously fed into the bottom of the dip tank and allowed to continuously overflow from the dip tank. The overflowing coating liquid may be collected in a vessel forming a reservoir and recycled to the coating bath.

It is known to dip coat an object in a coating device containing a bath of liquid coating material, a feeding inlet for feeding the coating material into the lower part of the coating bath, and a member for uniformizing the upward flow of the coating material from the lower part of the coating bath toward the upper part thereof. The member is located in the lower part of the coating bath and above the feeding inlet to intercept and direct the upward flow of the coating material along the entire wall periphery of the coating bath and provide a uniform and smooth flow of coating material around each portion of the object immersed in the coating bath. The foregoing techniques are described in U.S. Pat. No. 4,620,996, the entire disclosure of which is incorporated herein by this reference.

Typically, in a dip coating process, a coating solution or dispersion is applied to a drum. Dispersions usually comprise various components that are applied to a substrate to form an OPC including a charge generation layer and a charge transfer layer. These coating dispersions usually comprise two phases, such as solid particles dispersed in a solution of a film forming binder dissolved in a solvent. This mixture forms a non-ideal dispersion. In an ideal coating mixture, viscosity remains constant regardless of the amount of shear applied to the coating mixture. However, such ideal mixtures do not exist. In non-ideal coating compositions such as dispersions, viscosity tends to diminish rapidly with shear. Changes in viscosity affect the coating thickness of the deposited coating. This causes the coating on the surface of the drum to be uneven. The degree of uniformity of film thickness of the layers of the OPC on a photoreceptor contributes largely to its electrophotographic characteristics, thus, it is important to reduce unevenness in the thickness of these layers.

Typically, the charge transfer layer is applied using immersion or dip coating of a drum. In this process, the CTL solution is pumped into the bottom of a dip tube and allowed to overflow the top opening of the dip tube. The drum is sized to be received in the dip tube. The drum is lowered into the dip tube and then raised out of the dip tube. During raising of the drum from the dip tube, a meniscus forms at the surface of the solution and the exterior surface of the drum as a result of the surface tension of the liquid. The surface tension of the CTL solution affects the thickness of the coating of the drum.

The thickness of the CTL coating applied to a drum by the immersion coating process is dependent upon the surface tension of the CTL solution which is in turn dependent on the viscosity of the coating solution. In a typical immersion coating process, pump motors turn pump impellers that drive the CTL solution. Prior art dip coating processes typically set the pump speed at a rate that results in an upward flow rate of the CTL solution within the dip tube. The drum is dipped by lowering the drum into the tube. After being immersed for a period of time, the drum is removed from the dip tube by raising it out of the dip tube. In prior art dip coating processes, the drum is raised out of the dip tube at a rate of approximately three millimeters per second, i.e. the pull rate. The upward rate of flow of the CTL solution within the dip tube is approximately five millimeters per second in the prior art process. Thus there is a differential between the upward flow rate of the CTL solution in the tube and the pull rate of the drum of approximately two millimeters per second. This difference affects the shear rate of the solution at the meniscus. This differential creates a surface tension that affects the thickness of the CTL layer on the drum.

In prior art dip coating operations, the thickness of the CTL layer on the drum is controlled by controlling the pull rate of the drum. After drying, the thickness of the CTL layer is tested. If the CTL layer is too thick, the drum is discarded and the pull rate is increased to reduce the thickness of the CTL layer on subsequent drums. If the CTL layer is too thin, the out of tolerance drum is discarded and the pull rate is decreased to increase the thickness of the CTL on subsequent drums. Thus, there exists a need for improved quality control over the immersion coating process to reduce the material loss.

In accordance with one aspect of the disclosure, a method of manufacturing a photoconductive switching element includes the steps of providing a drum to be coated with a photoreceptor, providing a tube having an upper opening sized to receive the drum therethrough and configured to act as a CTL solution outlet and a CTL inlet lower than the CTL outlet, providing a motor driven pump for circulating CTL solution through the tube by forcing the CTL solution through the lower inlet, dipping the photoreceptor drum in the tube, withdrawing the photoreceptor drum from the tube, measuring the viscosity of the CTL solution and altering the pump motor angular velocity to control the thickness of the CTL solution deposited on the photoreceptor drum.

According to a second aspect of the disclosure a method of controlling the thickness of a coating layer on a coated article manufactured using an immersion or dip coating process utilizing a dip tank through which a coating solution is pumped at an initial flow rate by a motor driven pump includes dipping, sensing, withdrawing and adjusting steps. The dipping step involves dipping the article in the dip tank. The sensing step involves sensing the viscosity of the coating solution. The withdrawing step involves withdrawing the article from the dip tank at a pull rate, said pull rate and said flow rate exhibiting a differential rate. The adjusting step involves adjusting the differential rate at a time between the beginning of the dipping step and the end of the withdrawal step in response to the sensed viscosity. The differential rate may be adjusted by altering the flow rate of the coating solution.

According to yet another aspect of the disclosure a dip coating apparatus for immersion coating an article with a coating layer of a solution is provided. The apparatus includes a dip tank, a solution pumping system a controller and a viscometer. The dip tank is configured to receive the article therein and includes an upper opening sized to permit the article to pass therethrough, a solution outlet, and a solution inlet situated below the solution outlet. The solution pumping system pumps solution at a pump rate into the inlet of the dip tank to generate a vertical flow of solution within the dip tank between the inlet and the outlet. The pumping system includes a motor driven pump fluidly coupled to a source of solution and the inlet of the dip tank. The controller adjusts the pump rate. The adjustments to the pump rate vary the vertical flow rate of the solution. The viscometer measures the viscosity of the solution. The viscometer provides an input to the controller indicative of the measured viscosity of the solution. The controller adjusts the pump rate in response to the measured viscosity of the solution.

Additional features and advantages of the present invention will become apparent to those skilled in the art upon consideration of the following detailed description of preferred embodiments exemplifying the best mode of carrying out the invention as presently perceived.

### BRIEF DESCRIPTION OF THE DRAWINGS

A more complete understanding of the disclosed methods and apparatus can be obtained by reference to the accompanying drawings wherein:

FIG. 1 is a schematic elevation view with parts broken away of a coating vessel or dip tank;

FIG. 2 is a schematic elevation view with parts broken away of the dip tank shown in FIG. 1 containing a drum substrate which has an outside diameter that is only slightly smaller than the inside diameter of the dip tank;

FIG. 3 is a schematic elevation view with parts broken away of the dip tank and substrate of FIG. 2 with the substrate partially withdrawn from the dip tank during during immersion or dip coating of the substrate with a solution held in the dip tank;

FIG. 4 is a view of the section of FIG. 3 indicated by circle 4 showing the meniscus formed between the surface of the solution and the outside surface of the substrate and a coating of the solution adhering to the substrate;

FIG. 5 is a view similar to FIG. 4 showing a lower viscosity solution generating a thicker coating and a larger meniscus between the surface of the solution and the surface of the substrate;

FIG. 6 is a schematic illustration of a coating system for immersion coating a substrate with a layer of a solution circulated through dip tanks by a motor driven pump controlled in part by an error signal generated from the signal of a viscometer;

FIG. 7 is a block diagram of the disclosed system for controlling the thickness of a coating showing a viscometer sensing the viscosity of a solution flowing through a dip tank, a comparator generating an error signal based on the difference between the sensed viscosity and a setpoint viscosity, a logic circuit converting the viscosity error signal into a motor angular velocity error signal, a motor driver converting the angular velocity error signal into an angular velocity driver signal, a motor driven by the angular velocity signal driving a pump circulating the solution;

FIG. 8 is a flow diagram of an implementation of the method of controlling the thickness of a coating on a substrate including an initialization step, a sensing step a determination step and a flow rate adjustment step;

FIG. 9 is a flow diagram of an implementation of the determination step; and

FIG. 10 is a flow diagram of an implementation of the flow rate adjustment step of the flow rate adjustment step of FIG. 8.

These figures merely illustrate the disclosed methods and apparatus and are not intended to exactly indicate relative size and dimensions of the device or components thereof.

### DETAILED DESCRIPTION OF THE DRAWINGS

A method of controlling the thickness of a coating on a photoreceptor manufactured using an immersion or dip coating process is disclosed herein. A coating solution is pumped into a dip tank of an immersion coating system by a motor driven pump. In the disclosed method, the viscosity of the coating solution is sensed and the viscosity is adjusted by altering the flow rate of the coating solution within the coating system. Illustratively, the flow rate is altered by adjusting the angular velocity of the motor based upon the sensed viscosity. While the disclosed methods and apparatus is described with reference to a manufacturing process whereby a photoreceptor drum of a xerography machine is coated with a charge transfer layer by immersion coating the drum, the disclosure will be applicable to other manufacturing processes and to components of other devices that receive a controlled layer of material.

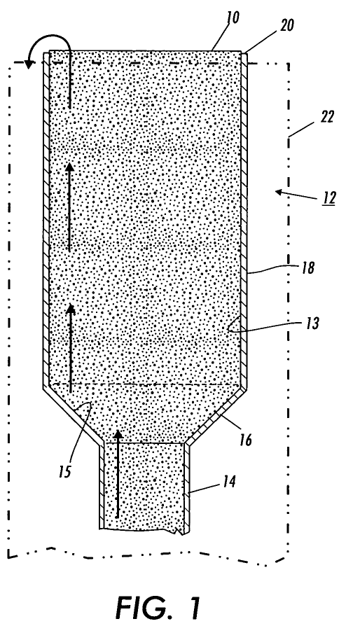

Immersion or dip coating apparatus including article transfer apparatus facilitating the raising, lowering and transferring of an article 24 to be coated, a dip tube 12 sized to receive an article 24 to be coated and a coating solution circulation system are known. Such an immersion coating apparatus is disclosed in U.S. Pat. No. 6,207,337, the disclosure of which is incorporated herein by this reference. Other article transfer apparatus are known and used in the immersion coating art. The disclosed method is described as being practiced utilizing such a transfer apparatus for lowering the substrate 24 into and raising the substrate 24 out of a dip tank 12 such as the dip tank shown in FIGS. 1-4.

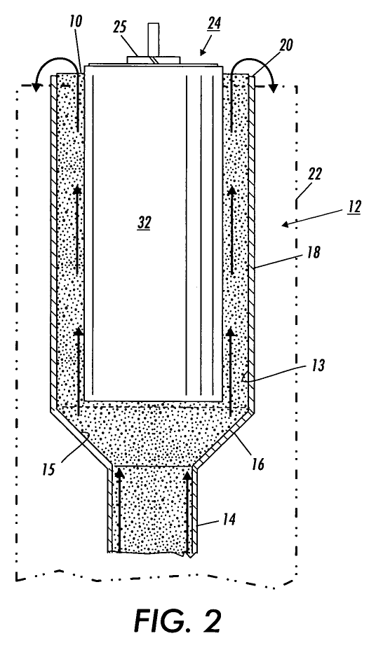

In the illustrated dip coating apparatus, the article to be coated is a cylindrical photoreceptor drum 24 of a photocopy machine. Thus, drum 24 has a length and a diameter. Consequently, the illustrated dip tank 12 has a length and diameter sufficient to facilitate receipt of the drum 24 substantially therein. The advantages of forming a dip tank 12 to conform closely to the shape and size of the article 24 to be coated are well known in the art. It is also well known in the art to leave a small portion of the article 12 to be coated extending beyond the top of the 20 of the dip tank 12 during the coating process in the manner shown, for example, in FIG. 2.

As shown, for example, in FIG. 1, a liquid coating material 10 forms a bath in the coating vessel or dip tank 12 having a feed inlet 14, inverted funnel-shaped bottom 16, vertical cylindrical wall 18 and top edge 20. As indicated by the arrows, the coating material 10 enters the dip tank 12 through the feed inlet 14, flows upwardly along an inverted funnel-shaped wall 15 and upwardly parallel to the vertical cylindrical wall 18, and overflows the top edge 20 of the vessel 12. The coating material that overflows top edge 20 is captured in a collecting tank 22 (partially shown by phantom lines).

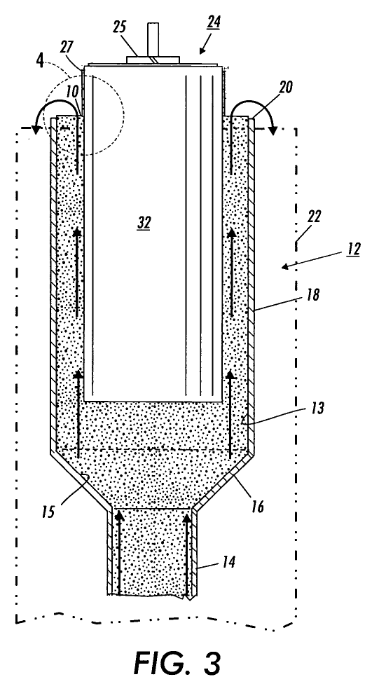

In FIG. 2, a dip tank 12 is illustrated with hollow cylindrical drum substrate 24 almost totally submerged in liquid coating material 10. Drum substrate 24 is suspended from a conventional mandrel 25 of an article transfer apparatus. The mandrel 25 grips the interior surface of drum substrate 24. Mandrel 25 also functions as an air tight seal to trap air in the interior of drum substrate 24 when the drum substrate 24 is immersed in the bath of liquid coating material 10 contained in vessel 12. In dip coating, air trapped within the lower interior space of the hollow drum substrate 24 prevents the liquid coating material 10 from entering and depositing on the interior surface of the substrate 24 and the lower end of the mandrel 25. Usually, a narrow peripheral strip around the top of drum substrate 24 is not submerged in the bath of coating material 10 and remains uncoated, as shown, for example, in FIGS. 2 and 3. As is well known in the dip coating art the mandrel 25 is connected to conventional transport means which lowers the drum substrate 24 into the bath of liquid coating material 10 and thereafter raises drum substrate 24 from the bath of liquid coating material 10. Examples of drum transport devices in a dip coating system are illustrated in U.S. Pat. Nos. 4,620,996 and 6,207,337, the disclosures thereof being incorporated herein by this reference. Subsequent to withdrawal from the bath of liquid coating material 10, drum substrate 24 carries a coating 27, 29 of the material from bath 10, as shown for example, in FIGS. 3-5.

Hollow cylindrical drum substrate 24 has an outer diameter that is only slightly smaller than the inner diameter of the dip tank 12. Thus, the radial spacing between the outer surface of hollow cylindrical drum substrate 24 and inner surface or wall of coating vessel 12 is extremely small. The drum substrate 24 should be substantially concentric with the inner surface of vertical cylindrical wall 18 of coating vessel 12 during the coating operation disclosed herein. In the illustrated embodiment, the radial spacing between the inner surface of vertical cylindrical wall 18 of coating vessel 12 and the outer surface of hollow cylindrical drum substrate 24 during the coating process is between about 2 millimeters and about 9 millimeters in order to reduce streaks and graininess in the final coating. Preferably, the radial spacing is between about 4.5 millimeters and about 8.5 millimeters. Optimum coating layers are achieved with an axial spacing between about 5.5 millimeters and about 7.5 millimeters. Since the expression “radial spacing” refers to the spacing between the outer surface of cylindrical drum substrate 24 and the inner surface of vertical cylindrical wall 18 of coating vessel 12 on only one side of the drum along an imaginary radius line, the “diametric spacing” is twice the size of the “radial spacing” because the diametric spacing includes the spaces on opposite sides of cylindrical drum substrate 24 measured along an imaginary diameter line. Thus, the diametric spacing is between about 4 millimeters and about 18 millimeters.

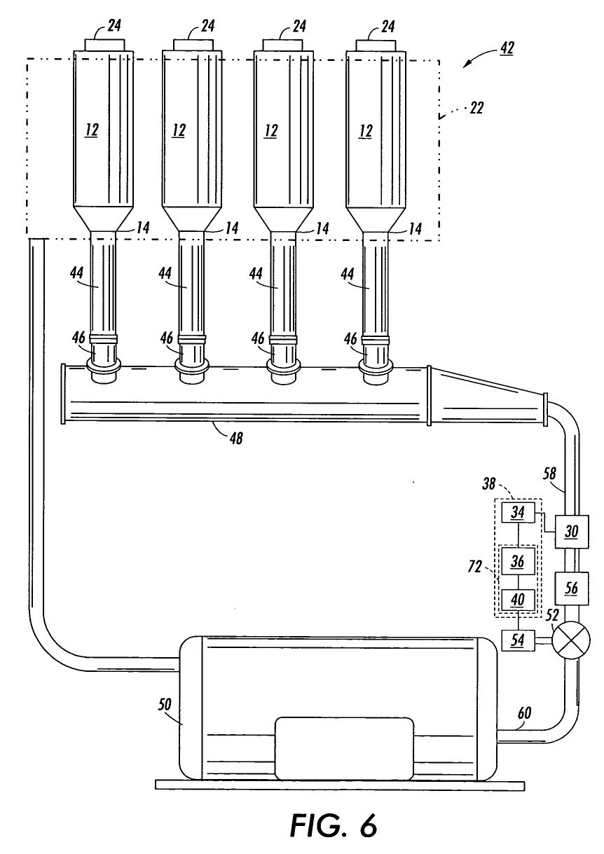

A coating system 42 utilizing eight dip tanks 12 is shown in FIG. 6 with only four dip tanks 12 being visible. Liquid coating material 10 is fed to these coating vessels through feed lines 44 which are connected in turn through elbow fittings 46 (the other four feed lines and elbow fittings not being visible in FIG. 6) to feed manifold 48. When the coating material 10 overflows from the coating vessels 12 into collecting tank 22 (shown in phantom lines), it flows by gravity (a pump may optionally be employed) to reservoir 50. From reservoir 50, the liquid coating material 10 is pumped by a suitable pump 52 driven by motor 54 through a low pressure filter 56 into the tapered inlet of manifold 48. All bends in the lines between reservoir 50 and the coating vessels 12 should have a large radius of curvature to maintain laminar flow motion of the liquid coating material 10 prior to introduction into the coating vessels 12. The liquid coating material 10 is delivered to the dip coating vessels 12 in laminar flow motion prior to introduction into each coating vessel 12 to ensure laminar flow within each coating vessel 12 and to prevent the formation of defects in the applied coating 27, 29.

All feed lines 58 and 60 from reservoir 50 preferably have smooth and electropolished interior surfaces. Thus, for example, the inner surface of each coating vessel and feed lines 44, elbow fittings 46 and manifold 48 should be smooth and free of burrs. Also, all piping should not impart sudden changes of direction or velocity to the liquid coating material 10, particularly, the manifold 48 which delivers the liquid coating material 10 to the individual coating vessels 12 with no change in relative velocity.

Generally, the cross-sectional area of manifold 48 should be equal to about the sum of the cross-sectional areas of each of the connecting lines 44 between the manifold 48 and the bottom inlet 14 of each coating vessel 12. Thus, all joints should have smooth and gradual transitions with absolutely no abrupt change in direction. Similarly, abrupt restrictions which would impede flow of the liquid coating material should be avoided in the liquid coating material delivery system 42 between the reservoir 5 and the bottom inlet 14 of each coating vessel 12.

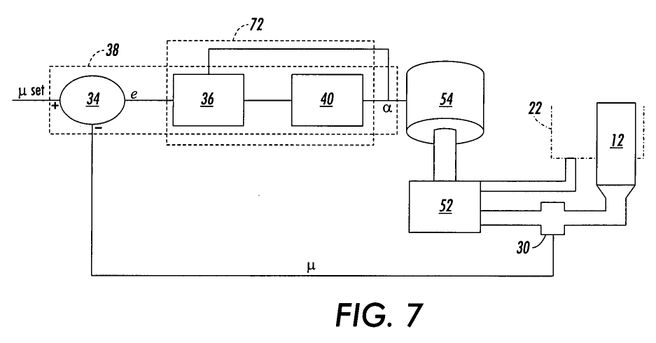

Devices which might cause a large pressure drop and disrupt laminar flow such as conventional filters, instrumentation, including temperature probes extending into the liquid flow path, and the like should be avoided. However, a low back pressure filter 56 and viscometer 30 may be utilized in the main feed line 58 between the manifold 48 and coating material pump 52. The coating material 10 pumped through this type of filter undergoes very little pressure drop because of the huge area available for filtering. Viscometer 30 is configured to avoid disruption of the laminar flow of coating material 10. As shown, for example, in FIG. 6, the output of viscometer 30 is coupled to an input of the PLC 38 to provide a feedback input to the comparator 34 implemented by the PLC. As shown, for example, in FIG. 7, the comparator 34 compares the value of the sensed viscosity p to the setpoint value of the viscosity μₛₑₜ to find the viscosity error Δμ represented by an error signal e. Illustratively, viscometer 30 is a plunger type viscometer available from Cambridge Applied Systems, Medfield, Mass., as model # BCC-32. Those skilled in the art will recognize that other viscometers and other sensors providing an indication of the viscosity of the coating material may be used within the scope of the disclosure. For example, an instrument for measuring the height of the meniscus could serve as a viscometer within the scope of the disclosure.

The illustrated dip coating system 42 transports and circulates liquid coating material 10 while isolating the coating material 10 from various energy inputs or losses in an effort to produce a consistently uniform and defect free coating. Thus, for example, sources of heat and vibration should be isolated from the liquid coating material in known manners.

The liquid coating material pump 52 preferably provides uniform delivery of the coating liquid 10 to a manifold 48 and each coating vessel 12. The pump 52 may be a low shear pump. Typical low shear pumps include, for example, sine pumps, auger pumps, centrifugal pumps, oil-less diaphragm pumps (acetal, teflon). Also included are two or three small pumps running out of phase with each other such as peristaltic pumps, sine pumps, auger pumps, centrifugal pumps, oil-less diaphragm pumps (acetal, teflon), and the like. In the illustrated embodiment, pump 52 is a gear pumps having an eight gallon per minute capacity available from Pulafeeder, Inc., a unit of IDEX Corporation, Rochester, N.Y. as an ISOCHEM™ gear pump. Since the illustrated method 100 controls thickness of a coating 27, 29 by adjusting pump motor angular velocity a based on a sensed value of the viscosity μ, it is preferable that pump 52 be driven by an adjustable speed motor 54 such as is the case with the ISOCHEM pump.

Satisfactory results of charge transfer layer coating thicknesses may be achieved with an upward liquid coating material velocity or flow rate of between about 15 millimeters per minute and about 400 millimeters per minute between the outer surface of the drum 24 and the vertical inner wall 18 of the coating vessel 12. The results of course vary with the material used as the coating solution 10, the viscosity of the coating solution 10, the pull rate of the substrate 24 and other parameters. The illustrated method 100 is practiced in an immersion coating system wherein charge transfer layer solution 10 is provided with an initial upward velocity or initial flow rate of approximately 300 millimeters per minute. This velocity is measured at the center of, i.e. midway between, the space between the cylindrical vessel wall 18 and the outer surface 32 of the drum 24 being coated as the drum 24 is being withdrawn from the liquid coating mixture 10.

Electro-statographic imaging members (photoreceptors) are well known in the art. The photoreceptor may be prepared by various suitable techniques. Typically, a substrate 24 is provided having an electrically conductive surface. At least one photoconductive layer is then applied to the electrically conductive surface. An optional thin charge blocking layer may be applied to the electrically conductive layer prior to the application of the photoconductive layer. For multilayered photoreceptors, a charge generation layer is usually applied onto the blocking layer and charge transport layer is formed on the charge generation layer. For single layer photoreceptors, the photoconductive layer is a photoconductive insulating layer and no separate, distinct charge transport layer is employed.

Any suitable size drum 24 may be coated with the process and apparatus disclosed herein. Typical drum diameters include, for example, diameters of about 30 millimeters, 40 millimeters, 85 millimeters, and the like. Preferably, the surface of the drum 24 being coated is smooth. However, if desired, it may be slightly roughened by honing, sand blasting, grit blasting, and the like. Such slight roughening forms a surface which varies from average diameter by less than about plus or minus 3 micrometers. The surface of the drum being coated is preferably inert to the components in the liquid coating material. The drum surface may be a bare, uncoated surface or may comprise a previously deposited coating or coatings. The substrate 24 may be opaque or transparent and may comprise numerous suitable materials having the required mechanical properties. Accordingly, the substrate may comprise a layer of an electrically non-conductive or conductive material such as an inorganic or an organic composition. As electrically non-conducting materials there may be employed various resins known for this purpose including polyesters, polycarbonates, polyamides, polyurethanes, and the like. Typical metal substrates include, for example, aluminum, stainless steel, nickel, aluminum alloys, and the like. The electrically insulating or conductive substrate should be rigid and in the form of a hollow cylindrical drum. Preferably, the substrate comprises a metal such as aluminum.

The thickness of the substrate layer depends on numerous factors, including resistance to bending and economical considerations, and thus this layer for a drum may be of substantial thickness, for example, about 5 millimeters, or of minimum thickness such as about 1 millimeter, provided there are no adverse effects on the final electro-statographic device.

The conductive layer may vary in thickness over substantially wide ranges depending on the optical transparency desired for the electro-statographic member. Accordingly, the conductive layer and the substrate may be one and the same or the conductive layer may comprise a coating on the substrate. Where the conductive layer is a coating on the substrate, the thickness of the conductive layer may be as thin as about 50 angstroms, and more preferably at least about 100 Angstrom units for optimum electrical conductivity. The conductive layer may be an electrically conductive metal layer formed, for example, on the substrate by any suitable coating technique, such as a vacuum depositing technique. Typical metals include aluminum, zirconium, niobium, tantalum, vanadium and hafnium, titanium, nickel, stainless steel, chromium, tungsten, molybdenum, and the like. Typical vacuum depositing techniques include sputtering, magnetron sputtering, RF sputtering, and the like.

After formation of an electrically conductive surface, a hole blocking layer may be applied thereto. Generally, electron blocking layers for positively charged photoreceptors allow holes from the imaging surface of the photoreceptor to migrate toward the conductive layer. Any suitable blocking layer capable of forming an electronic barrier to holes between the adjacent photoconductive layer and the underlying conductive layer may be utilized. Typical blocking layers include, for example, polyamides, polyvinylbutyrals, polysiloxanes, polyesters, and the like and mixtures thereof. The blocking layer may be nitrogen containing siloxanes or nitrogen containing titanium compounds such as trimethoxysilyl propylene diamine, hydrolyzed trimethoxysilyl propyl ethylene diamine, N-beta(aminoethyl) gamma-amino-propyl trimethoxy silane, isopropyl 4-aminobenzene sulfonyl, di(dodecylbenzene sulfonyl) titanate, isopropyl di(4-aminobenzoyl)isostearoyl titanate, isopropyl tri(N-ethylaminoethylamino)titanate, isopropyl trianthranil titanate, isopropyl tri(N,N-dimethyl-ethylamino)titanate, titanium-4-amino benzene sulfonate oxyacetate, titanium 4-aminobenzoate isostearate oxyacetate, (H₂N(CH₂)₄)CH₃Si(OCH₃)₂, (gamma-aminobutyl) methyl diethoxysilane, and (H₂N(CH₂)₃)CH₃Si(OCH₃)₂(gamma-aminopropyl) methyl diethoxysilane, as disclosed in U.S. Pat. No. 4,338,387, U.S. Pat. No. 4,286,033 and U.S. Pat. No. 4,291,110. The disclosures of U.S. Pat. No. 4,338,387, U.S. Pat. No. 4,286,033 and U.S. Pat. No. 4,291,110 are incorporated herein in their entirety.

For convenience in obtaining thin layers, the blocking layers are preferably applied in the form of a dilute solution, with the solvent being removed after deposition of the coating by conventional techniques such as by vacuum, heating and the like. The blocking layer should be continuous and have a thickness of less than about 0.2 micrometer because greater thicknesses may lead to undesirably high residual voltage. Drying of the deposited coating may be effected by any suitable conventional technique such as oven drying, infra red radiation drying, air drying and the like. It is within the scope of the disclosure for the disclosed method to be used to control the thickness of a blocking layer applied to a photoreceptor.

Any suitable photogenerating layer may be applied to the blocking layer. Examples of typical photogenerating layers include inorganic photoconductive particles such as amorphous selenium, trigonal selenium, and selenium alloys selected from the group consisting of selenium-tellurium, selenium-tellurium-arsenic, selenium arsenide and mixtures thereof, and organic photoconductive particles including various phthalocyanine pigment such as the X-form of metal free phthalocyanine described in U.S. Pat. No. 3,357,989, metal phthalocyanines such as vanadyl phthalocyanine and copper phthalocyanine, dibromoanthanthrone, squarylium, quinacridones available from DuPont under the tradename Monastral Red, Monastral violet and Monastral Red Y, Vat orange 1 and Vat orange 3 trade names for dibromo anthanthrone pigments, benzimidazole perylene, substituted 2,4-diamino-triazines disclosed in U.S. Pat. No. 3,442,781, polynuclear aromatic quinones available from Allied Chemical Corporation under the tradename Indofast Double Scarlet, Indofast Violet Lake B, Indofast Brilliant Scarlet and Indofast Orange, and the like dispersed in a film forming polymeric binder. Multi-photogenerating layer compositions may be utilized where a photoconductive layer enhances or reduces the properties of the photogenerating layer. Examples of this type of configuration are described in U.S. Pat. No. 4,415,639, the entire disclosure of this patent being incorporated herein by reference. Other suitable photogenerating materials known in the art may also be utilized, if desired. Charge generating binder layers comprising particles or layers comprising a photoconductive material such as vanadyl phthalocyanine, metal free phthalocyanine, benzimidazole perylene, amorphous selenium, trigonal selenium, selenium alloys such as selenium-tellurium, selenium-tellurium-arsenic, selenium arsenide, and the like and mixtures thereof are especially preferred because of their sensitivity to white light. Vanadyl phthalocyanine, metal free phthalocyanine and tellurium alloys are also preferred because these materials provide the additional benefit of being sensitive to infra-red light. Generally, the average particle size of the pigment dispersed in the charge generating layer is less than about 1 micrometer. A preferred average size for pigment particles is between about 0.05 micrometer and about 0.2 micrometer.

Any suitable polymeric film forming binder material may be employed as the matrix in the photogenerating binder layer. Typical polymeric film forming materials include those described, for example, in U.S. Pat. No. 3,121,006, the entire disclosure of which is incorporated herein by reference. Thus, typical organic polymeric film forming binders include resins such as polyvinylbutyral, polycarbonates, polyesters, polyamides, polyurethanes, polystyrenes, polyarylethers, polyarylsulfones, polybutadienes, polysulfones, polyethersulfones, polyethylenes, polypropylenes, polyimides, polymethylpentenes, polyphenylene sulfides, polyvinyl acetate, polysiloxanes, polyacrylates, polyvinyl acetals, polyamides, polyimides, amino resins, phenylene oxide resins, terephthalic acid resins, phenoxy resins, epoxy resins, phenolic resins, polystyrene and acrylonitrile copolymers, polyvinylchloride, vinylchloride and vinyl acetate copolymers, acrylate copolymers, alkyd resins, cellulosic film formers, poly(amideimide), styrene-butadiene copolymers, vinylidenechloride-vinylchloride copolymers, vinylacetate-vinylidenechloride copolymers, styrene-alkyd resins, polyvinylcarbazole, and the like and mixtures thereof. These polymers may be block, random or alternating copolymers.

Any suitable solvent may be employed to dissolve the film forming binder. Typical solvents include, for example, n-butyl acetate, methylene chloride, tetrahydrofuran, cyclohexanone, iso-butyl acetate, toluene, methyl ethyl ketone, and the like.

Satisfactory results may be achieved with a pigment to binder weight ratio of between about 40:60 and about 95:5. Preferably, the pigment to binder ratio is between about 50:50 and about 90:10. Optimum results may be achieved with a pigment to binder ratio of between about 60:40 and about 80:20 ratio.

Various factors affect the thickness of the deposited charge generating layer coating. These factors include, for example, the solids loading of the total liquid coating material, the viscosity of the liquid coating material, and the or differential relative velocity of the liquid coating material in the space between the drum surface and coating vessel wall. Satisfactory results are achieved with a solids loading of between about 2 percent and about 12 percent based on the total weight of the liquid coating material; the “total weight of the solids” being the combined weight of the film forming binder and pigment particles and the “total weight of the liquid coating material” being the combined weight of the film forming binder, the solvent for the binder and pigment particles. Preferably, the liquid coating mixture has a solids loading of between about 3 percent and about 8 percent by weight based on the total weight of the liquid coating material.

The thickness of the deposited coating varies with the specific solvent, film forming polymer and pigment materials utilized for any given coating composition. For thin coatings, a relatively slow drum withdrawal (pull) rate is desirable when utilizing high viscosity liquid coating materials. Generally, the viscosity of the liquid coating material varies with the solids content of the liquid coating material. Satisfactory results may be achieved with viscosities between about 1 centipoise and about 100 centipoises. Preferably, the viscosity is between about 2 centipoises and about 10 centipoises.

The photogenerating composition or pigment is present in the resinous binder composition in various amounts, generally, however, from about 5 percent by volume to about 90 percent by volume of the photogenerating pigment is dispersed in about 10 percent by volume to about 95 percent by volume of the resinous binder, and preferably from about 20 percent by volume to about 30 percent by volume of the photogenerating pigment is dispersed in about 70 percent by volume to about 80 percent by volume of the resinous binder composition. In one embodiment about 8 percent by volume of the photogenerating pigment is dispersed in about 92 percent by volume of the resinous binder composition.

After drying, the deposited charge generating layer thickness generally ranges in thickness of from about 0.1 micrometer to about 5 micrometers, and preferably between about 0.05 micrometer and about 2 micrometers. The desired photogenerating layer thickness is related to binder content. Higher binder content compositions generally require thicker layers for photogeneration. Thicknesses outside these ranges can be selected. It is within the scope of the disclosure for the charge generating layer to be applied to the photoreceptor substrate 24 using the disclosed method 100 with the various setpoints, limits and pull rates and differential rates adjusted to obtain the desired thickness.

The active charge transport layer may comprise an activating compound useful as an additive dispersed in electrically inactive polymeric materials to render these materials electrically active. These activating compounds may be added to polymeric materials which are incapable of supporting the injection of photogenerated holes from the generation material and incapable of allowing the transport of these holes therethrough. This will convert the electrically inactive polymeric material to a material capable of supporting the injection of photogenerated holes from the generation material and capable of allowing the transport of these holes through the active layer in order to discharge the surface charge on the active layer.

A typical transport layer employed in one of the two electrically operative layers in multilayered photoconductors comprises from about 25 percent to about 75 percent by weight of at least one charge transporting aromatic amine compound, and about 75 percent to about 25 percent by weight of a polymeric film forming resin in which the aromatic amine is soluble. The charge transport layer forming mixture may, for example, comprise an aromatic amine compound of one or more compounds having the general formula: 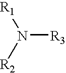
wherein R₁ and R₂ are an aromatic group selected from the group consisting of a substituted or unsubstituted phenyl group, naphthyl group, and polyphenyl group and R₃ is selected from the group consisting of a substituted or unsubstituted aryl group, alkyl group having from 1 to 18 carbon atoms and cycloaliphatic compounds having from 3 to 18 carbon atoms. The substituents should be free from electron withdrawing groups such as NO₂ groups, CN groups, and the like. Examples of charge transporting aromatic amines represented by the structural formulae above for charge transport layers capable of supporting the injection of photogenerated holes of a charge generating layer and transporting the holes through the charge transport layer include triphenylmethane, bis(4-diethylamine-2-methylphenyl)phenylmethane; 4′-4′-bis(diethylamino)-2′,2″-dimethyltriphenylmethane, N,N′-bis(alkylphenyl)-(1,1′-biphenyl)-4,4′-diamine wherein the alkyl is, for example, methyl, ethyl, propyl, n-butyl, etc., N,N′-diphenyl-N,N′-bis(chlorophenyl)-(1,1′-biphenyl)-4,4′-diamine, N,N′-diphenyl-N,N′-bis(3″-methylphenyl)-(1,1′-biphenyl)-4,4′-diamine, and the like dispersed in an inactive resin binder.

Any suitable inactive resin binder soluble in methylene chloride or other suitable solvent may be employed in the photoreceptor. Typical inactive resin binders soluble in methylene chloride include polycarbonate resin, polyvinylcarbazole, polyester, polyarylate, polyacrylate, polyether, polysulfone, and the like. Molecular weights can vary, for example, from about 20,000 to about 150,000.

Any suitable and conventional technique may be utilized to mix the charge transport layer coating mixture. A preferred coating technique utilizes the dip coating system and method of controlling the thickness of a coating disclosed herein. Various factors affect the thickness of the dip deposited charge transport layer coating. These factors include, for example, the solids loading of the total liquid coating material, the viscosity of the liquid coating material, and the relative velocity or differential rate of the liquid coating material 10 in the space between the drum surface 32 and coating vessel wall 18. Satisfactory results are achieved with a solids loading of between about 15 percent and about 35 percent based on the total weight of the liquid coating material 10; the “total weight of the solids” being the combined weight of the film forming binder and the activating compound and the “total weight of the liquid coating material” being the combined weight of the film forming binder, the activating compound and the solvent for the binder and activating compound. Preferably, the liquid charge transport layer coating mixture has a solids loading of between about 3 percent and about 6 percent by weight based on the total weight of the liquid coating material. The thickness of the deposited coating varies with the specific solvent, film forming polymer and activating compound utilized for any given coating composition.

For thin coatings, a relatively slow drum withdrawal (pull) rate is desirable when utilizing high viscosity liquid coating materials. Generally, the viscosity of the liquid coating material varies with the solids content of the liquid coating material. While the disclosed method, describes a CTL having a viscosity of 300 centipoises, satisfactory results may be achieved with viscosities between about 100 centipoise and about 1000 centipoises. Preferably, the viscosity is between about 200 centipoises and about 500 centipoises. Drying of the deposited coating may be effected by any suitable conventional technique such as oven drying, infra red radiation drying, air drying and the like.

Generally, the thickness of the hole transport layer is between about 10 to about 50 micrometers after drying, but thicknesses outside this range can also be used. The hole transport layer should be an insulator to the extent that the electrostatic charge placed on the hole transport layer is not conducted in the absence of illumination at a rate sufficient to prevent formation and retention of an electrostatic latent image thereon. In general, the ratio of the thickness of the hole transport layer to the charge generator layer is preferably maintained from about 2:1 to 200:1 and in some instances as great as 400:1.

Examples of photosensitive members having at least two electrically operative layers include the charge generator layer and diamine containing transport layer members disclosed in U.S. Pat. Nos. 4,265,990, 4,233,384, 4,306,008, 4,299,897 and 4,439,507. The disclosures of these patents are incorporated herein in their entirety. The photoreceptors may comprise, for example, a charge generator layer sandwiched between a conductive surface and a charge transport layer as described above or a charge transport layer sandwiched between a conductive surface and a charge generator layer.

Optionally, an overcoat layer may also be utilized to improve resistance to abrasion. Overcoatings are continuous and generally have a thickness of less than about 10 micrometers.

The disclosed method of controlling the thickness of a coating applied by dipping an article in a solution of the coating is described with regard to controlling the thickness of a CTL coating of a photoreceptor. It is within the scope of the disclosure to utilize the disclosed method 100 to control the thickness of other coatings on a photoreceptor such as the disclosed charge generator layer, hole-blocking layer or over coat layer when such layers are applied using an immersion coating process. It is also within the scope of the disclosure to utilize the disclosed thickness control method when immersion coating other articles with other solutions.

As shown for example in FIGS. 6 and 7, the coating solution circulation system includes a motor 54 driven pump 52 that circulates CTL solution 10 through a pipe 58 fluidly coupled to an inlet 14 of the dip tube 12. Pump 52 forces CTL solution 10 through the pipe 58 and inlet 14 into the dip tube 12. During start-up, the CTL solution 10 flows into and fills the dip tube 12 to the point of overflowing the top 20. CTL solution 10 flowing out of the top opening 20 of the dip tube 12 is collected in a reservoir for re-circulation by the pump 52.

In the illustrated embodiment, when the motor 54 of the pump 52 is turning at an angular velocity a, the CTL solution 10 exhibits a flow rate through the dip tube 12. In the illustrated embodiment, the flow rate is initially set to approximately five millimeters per second (i.e. 300 mm/min.) by setting the pump rate to 3.2 gallons per minute by adjusting the angular velocity of the motor 54 driving the pump 52 to approximately 40% of the rated angular velocity of the motor 54. Thus, in the disclosed system 42, the flow rate of the CTL solution 10 can be adjusted by adjusting the angular velocity of the motor 54 driving the pump 52.

It has been found that as the angular velocity of the motor 54 driving the pump 52 increases the viscosity of the CTL solution 10 decreases. Thus, if the angular velocity of the motor 54 driving the pump 52 is increased, the vertical flow rate of the CTL solution 10 is increased, the differential rate is decreased and the height 62, 64 of the meniscus 66, 68 formed between the surface 70 of the CTL solution 10 and the surface 32 of the substrate 34 is decreased resulting in a thinner coating adhering to the substrate 24. Over time, the viscosity of the CTL solution 10 also decreases as a result of the increase in angular velocity of the motor 54 driving the pump 52. A decrease in CTL solution viscosity causes the height 62, 64 of the meniscus 66, 68 formed between the surface 70 of the CTL solution 10 and the surface 32 of the substrate 24 to decrease. This results in a thinner layer of CTL adhering to the substrate 24. Thus, if the angular velocity of the motor 54 is increased, an almost immediate thinning of the coating layer 27, 29 is achieved as a result of the change in the differential rate resulting from the change in the flow rate. Over time, the coating layer 27, 29 will continue to become thinner as the viscosity of the CTL is lowered by the increase in the motor angular velocity. The opposite effects on differential rate, flow rate, meniscus height and viscosity are induced by decreases in angular velocity of the motor 54 driving the pump 52.

As previously stated, in the illustrated embodiment, pump 52 and motor 54 are an ISOCHEM 8 gpm motor driven gear pump available from, Pulafeeder, Inc., a unit of IDEX Corporation, Rochester, N.Y. These self-priming pumps yield a constant volume for a particular drive speed and provide linear pulsation-free flows. It is within the scope of the disclosure to use other types of pumps and prime movers actuating the pump to be used. It is preferable that the prime mover actuating the pump be able to be driven by a variable speed controller. Illustratively, pump driving circuit 72 includes a variable speed controller implemented using a controller 36 and a motor driver 40. Such variable speed controllers can be implemented using programmable logic circuits 38 such as the illustrated PLC-5 available from Allen Bradley, a division of Rockwell Automation, Milwaukee, Wis. In the illustrated embodiment, the PLC-5 implements not only the controller 36 and the driver 40 but also the comparator 34 for comparing the sensed viscosity to the setpoint viscosity. Other commercially available controllers may be utilized within the scope of the disclosure. It is also within the scope of the disclosure to use other logic circuits, processors, controllers, microprocessors, micro-controllers, programmable logic arrays or other components to implement a motor controller to vary the angular velocity of the motor 54 driving the pump 52.

A motor control software package is resident on the illustrated PLC 38. Illustratively software package is Allen Bradley, PLC-5 Ladder logistics type. It is also within the scope of the disclosure to use SLC50 software or other similar motor control software.

The disclosed embodiment of the closed loop control system for an OPC coating operation controls the viscosity of the coating fluid by controlling the pump speed. A viscometer 30 provides feedback to control the motor 54 of the fluid pump 52 to control the viscosity and flow rate of the coating fluid 10 in the critical initial portion of the coating where the sloping defect is often encountered. Sloping is a change in thickness as the drum 24 is pulled out of the dip solution 10. Slight changes in the viscosity of the coating solution 10 have been seen to change the thickness of the coating 27, 29 in this sensitive region. In some coating applications, a change of plus or minus 10 centipoise (10 cP) has been found to change the coating thickness enough to put it out of specification. In the illustrated embodiment of the coating method, a change of plus or minus 20 centipoise (20 cP) from the desired viscosity of the coating solution 10 is near the limit of tolerable viscosity error to obtain a coating 27, 29 of desired thickness.

By changing the angular velocity of the pump's motor 54 by two or three percent of the rated velocity, the viscosity of the coating solution 10 is controlled within limits and thus the coating uniformity and thickness is controlled. By programming the programmable logic controller 38 and providing the PLC 38 with an input from a viscometer 30, automatic adjustment of the viscosity is achieved and improved coating quality and yield are achieved. By regulating viscosity and flow rate of the coating solution 10 and the differential rate by regulating the angular velocity of the motor 54 driving the pump 52 more precise control over the uniformity and thickness of the OPC coating 27, 29 can be obtained than by simply adjusting the pull rate.

It is within the scope of this disclosure to use the illustrated method 100 to control the uniformity and thickness of the CTL layer 27, 29 through the use of the pump speed as a controlled parameter. To increase cycle times of photoresistor fabrication lines, it may be necessary for the CTL solution viscosity to be lowered. When viscosity is lowered, the quality of the CTL layer can go down Examination of pump speeds and viscosity in coating solution supply subsystems has established that, within limits, as pump speed increases, viscosity of the coating solution decreases. Thus, viscosity is inversely proportional to pump speed, within limits. Therefor, if the pump speed is increased, viscosity of the coating solution will be decreased.

In the prior art immersion coating systems, a CTL solution cart was utilized to provide CTL solution to an immersion coating system. Occasionally, operators lost control of the viscosity of the CTL coating solution in the CTL cart. When that happened the thickness of the CTL coating 27, 29 on the substrate 24 was outside of specifications by being either too thick or thin depending on the direction of the viscosity of the CTL solution 10 was out of specification. It has been found that if the viscosity CTL solution 10 is outside the specified parameters in either direction by more than 10 cP, changing the pump speed by two to three percent can bring the thickness of the CTL coating 27, 29 on the photoreceptor 24 back into the specified range of thickness. Since viscosity can be measured automatically using a viscometer 30, automatic control of the pump motor speed can be implemented. This control method can be implemented by adding a viscometer 30 to existing immersion control systems, coupling the viscometer output as an input to the PLC 38 typically present on the immersion coating system to control pump speed and other parameters and programming the PLC 38 to control the angular velocity of the motor 54 driving the pump 52 in response to the input from the viscometer 30. The PLC 38 receiving the viscosity information as an input changes the pump speed without input from the operator. Thus, the disclosed method 100 is more robust than the current set up. The disclosed method 100 and device 42 reduce losses of product in the immersion coating plants by reducing out of specification CTL layers 27, 29.

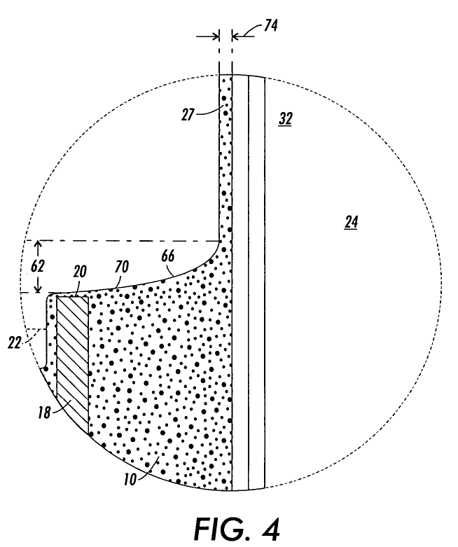

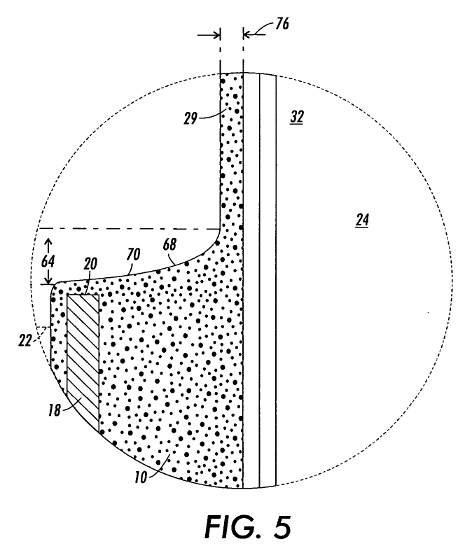

Reference is now made to FIGS. 4 and 5 illustrating the ramifications of changes in viscosity and differential rates on coating thicknesses. The differences illustrated in FIGS. 4 and 5 can be realized through either changing the viscosity of the coating solution or changing the differential rate. It has been found that as the angular velocity of the motor 54 driving the pump 52 is lowered, the height 64 of the meniscus 68 formed between the surface 70 of the coating solution 10 and the surface 32 of the substrate 24 being withdrawn from the coating solution 10 increases, as shown, for example, in FIG. 5. This results in the thickness 76 of the coating 29 being thicker. Similarly, as the angular velocity of the motor 54 driving the pump 52 is increased, the height 62 of the meniscus 66 formed between the surface 70 of the coating solution 10 and the surface 32 of the substrate 24 being withdrawn from the coating solution 10 decreases, as shown, for example, in FIG. 4. This results in the thickness 74 of the coating 27 being thinner.

It has been recognized that a driving factor in the dried thickness of the layer is the meniscus height during the coating operation. Historically, the meniscus height has been controlled by varying the rate at which the photoreceptor is extracted form the coating dip tube. This process works very well but changes to the profile cannot be implemented in a timely manner. Thus, the thickness of the coating on at least one photoreceptor must approach or exceed the acceptable limits and that photoreceptor must be tested by quality control before the pull rate can be modified. It has been found that the meniscus height can be controlled by modifying pump speed, within limits, so as to achieve the same results recognized by modification of the pull rate. Since pump speed can easily be modified during the dipping cycle, thickness of a coating layer can be controlled with feedback. Since the meniscus height is proportional to the viscosity of the solution, a viscometer 30 can provide a feedback signal for controlling the angular velocity of the motor 54 driving the pump 52. Thus, by automatically or manually monitoring viscosity, pump speeds can be adjusted instantly when viscosity begins to deviate from its setpoint. Thus the meniscus height and thickness of the coating layer on the photoreceptor is controlled reducing loss of product.

By way of example, a prior art immersion coating system has been found to produce photoreceptors having a CTL layer of a desired thickness when the CTL solution viscosity is 300 centipoise, the pump speed is at 40% providing a vertical flow rate of 300 mm/min. and the substrate 24 is withdrawn from the dip tank 12 at a pull rate of 125 mm/min. Under the prior art process, if the viscosity of the CTL solution 10 were to climb to 320 cP, the thickness of the CTL layer on the photoreceptor would reach the upper limit of the thickness specifications. In the prior art manufacturing method, the batch being dipped at the time of the viscosity increase beyond 320 cP would likely be marked as rejects and scrapped as the coating thickness would likely be out of specification when tested. To compensate for the viscosity increase, in the prior process, the pull rate would be dropped to 120 mm/min to lower the height of the meniscus. However, if the viscosity is again adjusted toward the desired value of 300 cP the 120 mm/min. pull rate would result in the CTL layer on the photoreceptor being too thin again resulting in rejection of the part by quality control. If, once the viscosity value is within 10 cP of the setpoint, operators change the pull rate back to the nominal pull rate scrap could be reduced. However, if the pull rate is not adjusted and if the viscosity returns to normal during a coating cycle, the coating on the article would likely be too thin and that batch would be marked as rejects.

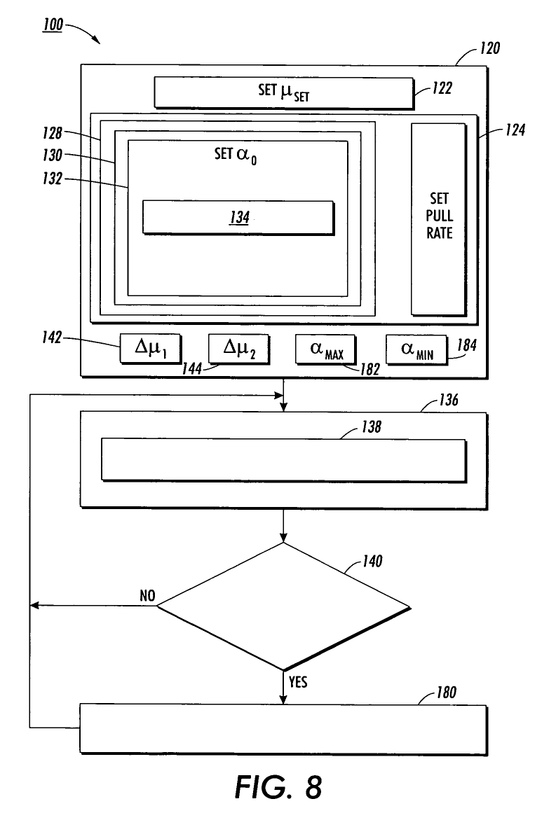

Under the disclosed method 100, the viscosity is initially set to 300 cP, the pull rate is initially set to 125 mm/min. and the initial angular velocity of the motor is set to 40% to produce a vertical flow rate of 300 mm/min. for the solution within the dip tank. As shown, for example, in FIG. 8, the viscosity setpoint μₛₑₜ is set in step 122, the pull rate is set in step 124 and the initial angular velocity α₀ of the motor 54 driving the pump 52 is set in step 132 of the initialization step 120. In the illustrated device 42 and method 100, the viscosity setpoint μₛₑₜ, initial angular velocity α₀ and pull rate is stored in the PLC 38. A viscosity meter 30 constantly monitors the viscosity μ of the CTL solution 10 in step 136 and provides feedback to the motor controller 38. The motor controller 38 compares the sensed viscosity μ to the setpoint viscosity μₛₑₜ in step 140 and adjusts the motor speed accordingly in step 180.

For example, if the viscometer 30 senses that the viscosity of the CTL solution 10 has risen to 320 cP, the motor controller 38 recognizes the +20 cP error and adjusts the motor angular velocity to 43%. This sensing and adjustment takes place while the substrate 24 is in the dip tank 12 and during withdrawal of the substrate 24 from the dip tank 12. In other words, sensing and control are implemented during the dipping cycle. Thus, even if the viscosity changes during a dip cycle, adjustments are made to the motor speed and the upward flow rate to adjust the meniscus height to avoid coating the substrate with a CTL layer that is not within tolerances. The immersion coating process continues normally. In the illustrated device 42 and method 100, once the viscosity μ drops to a value that is ±10 cP of the setpoint μ₀, the motor controller 38 adjusts the pump speed back to the nominal 40%.

Thus, as shown, for example, in FIG. 8, the coating process is initialized in step 120. Initialization 120 includes the steps of determining the desired thickness of the coating to be applied to the article and based upon this desired thickness establishing a viscosity setpoint μₛₑₜ 122 of the solution, establishing a differential rate 124 between the vertical flow rate of the solution and the pull rate of the article. Thus, the step of establishing a differential rate 124 includes the steps of establishing a pull rate 126 of the article and establishing an initial vertical flow rate 128 of the solution. When implemented in the disclosed immersion coating system, the establishing an initial flow rate step 128 is accomplished by establishing an initial pump rate 130. In the illustrated immersion coating system 42 and method 100 wherein the pump 52 is directly driven by a motor 54, the establishing an initial pump rate step 130 is accomplished by establishing an initial motor angular velocity α₀ 132. When a PWM motor controller is utilized to drive the motor 54 driving the pump 52, the establishing an initial motor angular velocity step 132 comprises establishing an initial PWM duty cycle 134 of the motor 54. In the illustrated embodiment, the establishing a differential rate step 124 is illustratively accomplished by establishing a pull rate of 125 mm/min. and an initial vertical flow rate of 300 mm/min. which is achieved by setting the initial pump speed at 40% by setting the initial controller output to provide a 40% of the rated angular velocity to the motor driver circuitry. Those skilled in the art will recognize that the values selected in the initialization step 120 are dependent upon the coating process being implemented. The process of selecting the appropriate initial values for viscosity, pull rate and pump speed to obtain the desired coating thickness is well known.

Those skilled in the art will recognize that the initialization step 120 goes beyond merely determining values but includes the necessary steps of providing an immersion coating apparatus configured to immerse articles in a dip tank and withdraw them at the set pull rate and to pump solution initially having a viscosity approximately equal to the setpoint value through the dip tank at the desired vertical flow rate. Once the system is initialized, the motor 54 driving the pump 52 is driven at the initial angular velocity to generate an initial vertical flow rate in the dip tank 12. The viscosity of the solution 10 is sensed 136. Illustratively, the viscosity sensing step 136 is accomplished by providing a viscometer 30 positioned to sense the viscosity of the solution 138 and analyzing the output of the viscometer 30.

Once the viscosity has been sensed 136, it is determined in step 140 whether it is necessary to adjust the differential rate based upon the sensed viscosity reading. If it is not necessary to adjust the differential rate, the sensing step 136 and determination step 140 are repeated. If it is necessary to adjust the differential rate, the differential rate is adjusted in step 180 and then the sensing step 136 and determination step 140 are repeated.

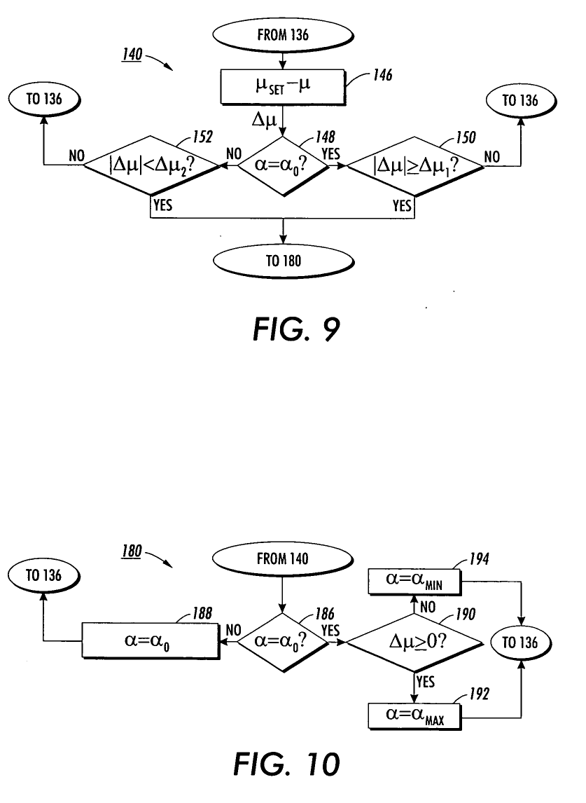

As shown for example, in FIG. 9, in the illustrated embodiment, the determination step 140 includes multiple sub-steps. FIG. 9 shows the sub-steps performed by the disclosed system 42. As part of the initialization step 120 in the disclosed system 42, a first viscosity deviation limit Δμ₁ is established 142 and a second viscosity deviation limit Δμ₂ is established 144. The first viscosity deviation limit Δμ₁ is the minimum value by which the viscosity μ of the coating solution 10 must differ from the setpoint viscosity μₛₑₜ before the flow rate is changed from the initial flow rate to some other value. The second viscosity deviation limit Δμ₂ is the value that the absolute value of the difference between the sensed viscosity μ and the setpoint viscosity μₛₑₜ can not exceed in order for the flow rate to be returned to the initial flow rate.

First, a comparison step 146 is performed to compare the sensed viscosity μ and the setpoint viscosity μₛₑₜ to determine a viscosity error Δμ. In the illustrated device 42, the viscosity error Δμ is represented by a signal e output by the comparator 34 that acts as an input to the motor controller 72 comprising a controller 36 and a motor driver circuit 40. In the illustrated device 42, the comparator34, controller 36 and motor driver are all implemented by software on the PLC 38

After the comparison step 146 is performed, a step 148 is performed to determine whether the current flow rate is equal to the initial flow rate. Referring to step 128, those skilled in the art will recognize that step 148 may be performed by determining if the current pump rate is equal to the initial pump rate, determining if the current motor angular velocity α is equal to the initial motor angular velocity α₀, or determining if the current duty cycle of the PWM driving the motor is equal to the initial PWM duty cycle. Other parameters of the system can be compared to initial parameters of the system to determine if the current flow rate is equal to the initial flow rate in step 148 within the scope of the disclosure. Thus, the presence of the “α=α₀?” language in block 148 should not be seen as limiting the manner of performing step 148. Similarly, the presence of any abbreviations in the drawings should not be interpreted as narrowing the scope of the claims.

If the current flow rate is equal to the initial flow rate, illustratively if the motor speed is 40% or α=α₀, then the absolute value of the viscosity error |Δμ| is compared to the first viscosity deviation limit Δμ₁ in step 150. If the absolute value of the viscosity error |Δμ| is not greater than or equal to the first viscosity deviation limit Δμ₁, the flow rate is not changed and the sensing step 136 and comparing step 140 are repeated. If the absolute value of the viscosity error |Δμ| is greater than or equal to the first viscosity deviation limit Δμ₁, the flow rate change step 180 is performed. During the flow rate change step 180 in the illustrated embodiment, the flow rate is changed from the initial flow rate to an upper or lower flow rate limit depending on whether the sensed viscosity μ is greater than or less than the setpoint viscosity μₛₑₜ, i.e. whether Δμ is positive or negative.

If the current flow rate is not equal to the initial flow rate, illustratively if the motor speed is higher or lower than 40% or α≠α₀, then the absolute value of the viscosity error |Δμ| is compared to the second viscosity deviation limit Δμ₂ in step 152. If the absolute value of the viscosity error |Δμ| is not less than the second viscosity deviation limit Δμ₂, the flow rate is not changed and the sensing step 136 and comparing step 140 are repeated. If the absolute value of the viscosity error |Δμ| is less than the second viscosity deviation limit Δμ₂, the flow rate change step 180 is performed. During the flow rate change step 180 in the illustrated embodiment, the flow rate is changed back to the initial flow rate from the upper or lower flow rate limit.

As shown for example, in FIG. 10, in the illustrated embodiment, the flow rate change step 180 includes multiple sub-steps. FIG. 10 shows the sub-steps performed by the disclosed system. As part of the initialization step 120 in the disclosed system, an upper flow rate limit is established by establishing an upper motor angular velocity αₘₐₓ in step 182 and a lower flow rate limit is established by establishing an upper motor angular velocity αₘᵢₙ in step 184.

A step 186 is performed to determine whether the current flow rate is equal to the initial flow rate. Referring to step 128, those skilled in the art will recognize that step 186 may be performed by determining if the current pump rate is equal to the initial pump rate, determining if the current motor angular velocity a is equal to the initial motor angular velocity α₀, or determining if the current duty cycle of the PWM driving the motor is equal to the initial PWM duty cycle. Other parameters of the system can be compared to initial parameters of the system to determine if the current flow rate is equal to the initial flow rate in step 186 within the scope of the disclosure.

The illustrated embodiment only permits the motor to be run at the initial angular velocity α₀ or at one or the other of the angular velocity upper limit αₘₐₓ or the angular velocity lower limit aₘᵢₙ. Thus, if step 180 is reached, the angular velocity of the motor is either set to the initial angular velocity α₀ if the motor is currently running at one or the other of the angular velocity upper limit αₘₐₓ or the angular velocity lower limit αₘᵢₙ or to one or the other of the angular velocity upper limit αₘₐₓ or the angular velocity lower limit αₘᵢₙ if the motor is currently running at the initial angular velocity α₀.

In the illustrated embodiment, if the current flow rate is not equal to the initial flow rate, in step 188 the flow rate is changed back to the initial flow rate. If the change flow rate step 180 is reached and the current flow rate is not the initial flow rate, then the flow rate is changed back to the initial flow rate. In the illustrated embodiment, the motor angular velocity a is set to the initial motor angular velocity α₀ in step 188.

In the illustrated embodiment, if the current flow rate is equal to the initial flow rate, in step 190 it is determined whether the viscosity error Δμ is positive or negative. If the viscosity error Δμ is positive, the flow rate is increased in step 192. In the illustrated embodiment, this increase in flow rate is implemented by changing the motor angular velocity to the angular velocity upper limit αₘₐₓ in step 192. If the viscosity error Δμ is negative, the flow rate is decreased in step 194. In the illustrated embodiment, this decrease in flow rate is implemented by changing the motor angular velocity to the angular velocity lower limit αₘᵢₙ in step 194.

Once the flow rate is changed in step 180 by implementing either step 188, step 192 or step 194, the sensing step 136 and determining step 140 are repeated.

In the disclosed embodiment, flow rate of the solution is adjusted in response to the viscosity error. Those skilled in the art will recognize that increasing the flow rate has a similar effect as that caused by decreasing the pull rate since both affect the differential rate. Similarly, decreasing the flow rate has a similar effect to increasing the pull rate. However, it is believed that adjusting the flow rate by adjusting the speed of the motor driving the pump affects not only the differential rate but also affects the viscosity of the solution being pumped. The height of the meniscus formed between the surface of the solution and the surface of the substrate being coated is affected by both the differential rate and the viscosity of the solution. As previously mentioned, the height of the meniscus affects the thickness of the coating adhering to the substrate.

The prior art immersion coating systems and methods of controlling coating layer thickness in an immersion coating process adjusted the pull rate to control the thickness of the layer deposited on the article being coated. This modification in the pull rate was implemented between dipping cycles, not during dipping cycles. The disclosed system and method adjust the differential rate during dipping cycles by adjusting the flow rate. While the illustrated device leaves the pull rate constant, and adjusts the motor angular velocity, it is within the scope of the disclosure to adjust the pull rate during a dipping cycle based on the value of the sensed viscosity.

Additionally, the disclosed system implements flow rate control by using a motor controller to control the angular velocity of the motor driving the pump in response to the sensed viscosity. The illustrated method requires the viscosity error to reach certain specified limits before adjustments are made to the motor angular velocity. In the illustrated system and method, once those limits are reached, only incremental changes are made to the angular velocity of the motor. Implementation of the illustrated system 42 and method 100 requires very little memory and processing power and can be implemented using relay ladder logic controllers like the illustrated PLC 38. Thus the illustrated system and method can be implemented in immersion coating systems having little memory or processing power. The illustrated method and system, thus can be implemented in most existing immersion coating systems at a very low cost.

However, it is within the scope of the disclosure for a more robust system to be implemented wherein the viscosity error signal is used to implement proportion, differential, integral, PI, PD, PID or another control algorithm to control the differential rate. This control of the differential rate may include controlling the pull rate and/or controlling the flow rate by controlling the pump rate, the motor angular velocity, the duty cycle of the motor driver or other parameter of the system. The envisioned robust control system could be implemented using continuous control of the flow rate wherein the flow rate is variable continuously or using incremental control of the flow rate wherein the flow rate is variable incrementally.

Such continuous or incremental alternative control systems may be bounded systems wherein the flow rate is controlled within limits. In the illustrated embodiment, the angular velocity upper limit is 43% and the angular velocity lower limit is 37% based on an initial angular velocity of 40%. It is within the scope of the disclosure for the bounds of the control system to be set at the disclosed limits or at other limits. It was found during testing of certain immersion coating apparatus that adjustments to flow rates could compensate for changes in viscosity within limits. The illustrated limits are those discovered in testing. It is within the scope of the disclosure to use different limits on flow rate adjustment.

While the disclosed methods and apparatus are described with reference to a manufacturing process whereby a photoreceptor drum of a xerography machine is coated with a charge transfer layer by immersion coating the drum, the disclosure will be applicable to other manufacturing processes and to components of other devices that receive a controlled layer of material.

Although the invention has been described with reference to specific preferred embodiments, it is not intended to be limited thereto, rather those having ordinary skill in the art will recognize that variations and modifications may be made therein which are within the spirit of the invention and within the scope of the claims.

1. A method of manufacturing a photoreceptor includes the steps of:
providing a substrate to be coated with a charge transfer layer (“CTL”);
providing a tube having an upper opening sized to receive the substrate therethrough and configured to act as a solution outlet and a inlet lower than the CTL outlet;
providing a motor driven pump for circulating CTL solution through the tube by forcing the CTL solution through the lower inlet;
filling the tube with CTL solution;
circulating the CTL solution using the motor driven pump;
dipping the substrate in the tube;
withdrawing the substrate from the tube;
measuring the viscosity of the CTL solution and altering the pump motor angular velocity to control the thickness of the CTL solution deposited on the substrate.

2. The method of claim 1 wherein the measuring step is performed during the withdrawing step.

3. The method of claim 1 wherein the altering the pump motor angular velocity step is performed during the withdrawing step.

4. The method of claim 3 wherein the measuring step is performed during the withdrawing step.

5. The method of claim 4 wherein the substrate is a drum.

6. The method of claim 1 wherein the circulating step induces the CTL to have a vertical flow rate and the withdrawing step is performed at a pull rate, and the pull rate is less than the vertical flow rate.

7. A method of controlling the thickness of a coating layer on a coated article manufactured using an immersion or dip coating process utilizing a dip tank through which a coating solution is pumped at an initial flow rate by a motor driven pump includes:
dipping the article in the dip tank;
sensing the viscosity of the coating solution;
withdrawing the article from the dip tank at a pull rate, said pull rate and said flow rate exhibiting a differential rate;
adjusting the differential rate by altering the flow rate of the coating solution in response to the sensed viscosity.

8. The method of claim 7 wherein the flow rate is altered by adjusting the angular velocity of the motor.

9. The method of claim 7 and further comprising the steps of establishing a viscosity setpoint, establishing a motor speed nominal velocity to generate the initial flow rate.

10. The method of claim 9 wherein the flow rate is adjusted from the initial flow rate when the sensed viscosity differs from the setpoint viscosity by a predetermined amount.

11. The method of claim 10 wherein the predetermined amount is between 5 to 30 centipoise.

12. The method of claim 10 wherein the predetermined amount is between about 15 and about 25 centipoise.

13. The method of claim 10 and further comprising the steps of repeating the sensing of the viscosity step after the adjusting the flow rate from the initial flow rate step and returning the flow rate to the initial flow rate in response to the sensed viscosity when the differential between sensed viscosity and the setpoint viscosity is within a second predetermined amount.

14. The method of claim 13 wherein the second predetermined amount is substantially less than the first predetermined amount.

15. The method of claim 14 wherein the second predetermined amount is not more than about a half of the first predetermined amount.

16. The method of claim 15 wherein the flow rate is adjusted by adjusting the angular velocity of the motor driving the pump.

17. A dip coating apparatus for immersion coating an article with a coating layer of a solution, the apparatus comprising:
a dip tank configured to receive the article therein, said dip tank including an upper opening sized to permit the article to pass therethrough, a solution outlet, and a solution inlet situated below the solution outlet;
a solution pumping system for pumping solution at a pump rate into the inlet of the dip tank to generate a vertical flow of solution within the dip tank between the inlet and the outlet, the pumping system comprising a motor driven pump fluidly coupled to a source of solution and the inlet of the dip tank;
a controller for adjusting the pump rate whereby adjustments to the pump rate vary the vertical flow rate of the solution;
a viscometer for measuring the viscosity of the solution, the viscometer providing an input to the controller indicative of the measured viscosity of the solution, and
wherein the controller adjusts the pump rate in response to the measured viscosity of the solution.

18. The apparatus of claim 17 wherein the controller controls the angular velocity of the motor.

19. The device of claim 18 and further comprising a plurality of such dip tanks, a manifold fluidly coupled to the pump and the inlets of the plurality of manifolds, a reservoir for capturing solution flowing out of the outlets of the plurality of dip tanks and being fluidly coupled to the pump.

20. The device of claim 19 wherein the viscometer is located in the pumping system disposed between the motor driven pump and the inlet of the dip tank.
